(19) United States
(12) Patent Application Publication
(10) Pub. No.: US 2008/0017705 A1
(43) Pub. Date: Jan. 24, 2008

(54) Method to reduce authentication latency in an immobilizer system

(75) Inventors: John R. Costello, Rochester Hills, MI (US); James P. Brecht, Shelby Township, MI (US); Tejas B. Desai, Troy, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/725,002

(22) Filed: Mar. 16, 2007

Related U.S. Application Data
(60) Provisional application No. 60/782,901, filed on Mar. 16, 2006.

(51) Int. Cl. G06K 5/00

(52) U.S. Cl. 235/380

(57) ABSTRACT

An immobilizer system begins authentication of an identification device in response to an external triggering event. The external triggering event occurs prior to engagement with a reader module within the vehicle. Authorization commences prior to engagement to the reader module and continues after engagement with the reader module to reduce perceived authentication wait time.

### CROSS REFERENCE TO RELATED APPLICATION

The application claims priority to U.S. Provisional Application No. 60/782,901 which was filed on Mar. 16, 2006.

### BACKGROUND OF THE INVENTION

This invention generally relates to a method and system for authenticating an identification device. More particularly, this invention relates to a method and system that begins authentication of an identification device prior to physical reading of an identification device.

Conventional remote keyless entry systems utilize a key fob to send an identification and authorization signal to a vehicle. The vehicle confirms the identification and authorization information and allows entry and operation to the vehicle if proper. Some more premium systems require only that a user be proximate the vehicle in order to verify identity and authorize operation. In other less expensive, or back-up systems, an affirmative action such as swiping a card or placing a key fob within a defined space are required before operation of the vehicle is permitted.

Because of the increased popularity and demand of keyless vehicle systems many less expensive vehicles are being equipped with the keyless authentication system that require swiping of a card or placing of the key fob in a defined space. Unfortunately, in such systems there can be an undesirable wait time after the swipe or placement of the identification device. The wait time is caused by the various authentication and comparison steps that are required to prevent unauthorized access and overcome possible electronic interference generated by other devices. This wait can be of a duration that causes an impression of low quality or of a problem, that can result in consumer dissatisfaction.

Accordingly, it is desirable to design and develop a process for reducing wait times for a passive authentication system while still providing a desired level of security.

### SUMMARY OF THE INVENTION

An example security system begins an authorization process prior to engagement of an identification device with an identification device reader.

An disclosed example vehicle immobilizer system identifies and begins authentication in response to an external trigger other than engagement with the reader. The external triggering event can include the opening of the door or the communication and actuation by a remote keyless entry device such as through actuation of a key FOB. Once the external trigger is implemented the immobilizer system begins searching for identification devices within the area. This begins the authentication process prior to any actuation or reading by the reader module.

The pre-authorization process begins in response to this external trigger and continues even if the identification device is engaged with a reader sometime during the authorization process. The authorization process then continues from the initial point prior to engagement with the reader module until such time as authentication has been verified and operation of the vehicle has been approved.

Accordingly, the system and method disclosed reduces waiting time for authentication of an identification device for an immobilizer system.

These and other features of the present invention can be best understood from the following specification and drawings, the following of which is a brief description.

### BRIEF DESCRIPTION OF THE DRAWINGS

FIG. 1 is a schematic representation of an example immobilizer system for a vehicle.

### DETAILED DESCRIPTION OF THE PREFERRED EMBODIMENT

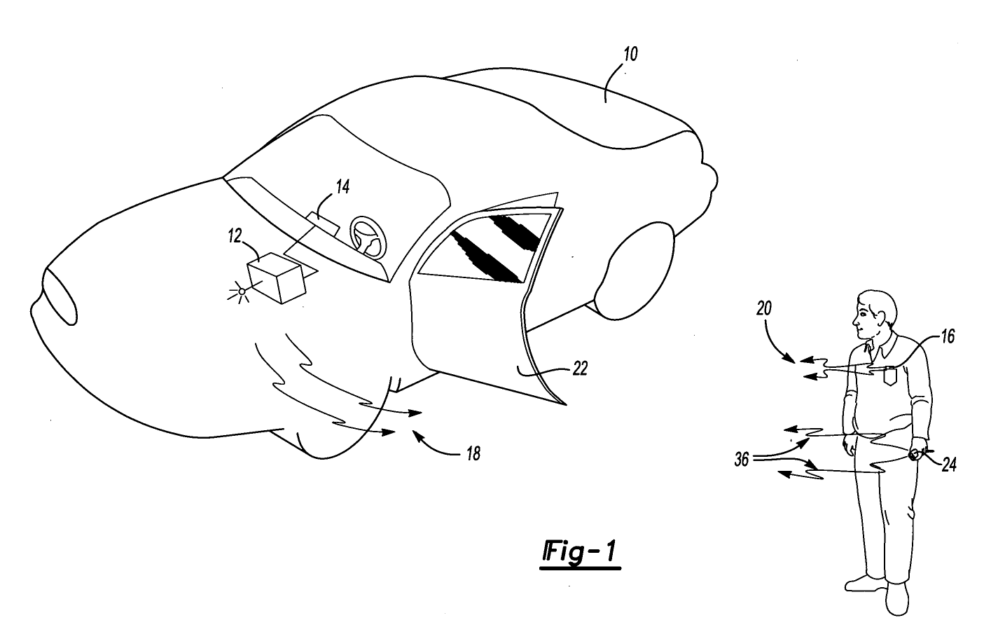

Referring to FIG. 1, an example immobilizer system 12 that prevents operation of the vehicle 10 until such time as an identification device such as an ID card 16 is identified and verified. Verification of an identification device such as the ID card 16 is accomplished by placing the ID card 16 within a reader module 14. In the example, the reader module 14 comprises a card reader that initializes the authorization process responsive to the ID card 16 being placed in proximity with the reader module 14. However, this process can take a lengthy time period and therefore the example method and system begins the authorization process prior to engagement with the reader module 14.

The example method begins the authorization process in response to an external triggering event. An example external triggering event can include the opening of a car door 22 or the actuation of the remote keyless entry device such as a key fob 24. Further, although the example method is illustrated as it relates to an automotive application, other applications such as for building access security systems for example could also benefit from this method described. The example key fob 24 sends a signal 26 that unlocks and allows access to the vehicle. The signal 26 triggers the authorization process.

Additionally, although a key fob 24, or opening of door 22 are described and illustrated, other actions can be utilized to trigger the authorization process. Such other devices and methods of triggering the authorization device can include activation of a vehicle proximity sensor, receipt of a vehicle bus message or any other prompt or action that serves to “wake” up the vehicle and begins some entry or authorization process.

The example immobilizer system 12 prevents operation of the vehicle 10 until such time as the veracity of the identification device such as for example an ID card 16, is verified. Authorization and verification begins in response to the external triggering event. Once the external triggering event is recognized the immobilizer system 12 sends a prompt signal 18 in search of an identification device proximate to the vehicle 10 and the immobilizer system 12.

The identification device, such as the example ID card 16 emits a signal 20 that contains information, and code utilized to determine if authorization should be allowed. The identification signal 20 is then verified by the immobilizer system 12. The verification process includes several steps. These steps can include known processes to separate the signal 20 from surrounding noise and to verify that the signal is in fact a signal from a valid and known identification device. The process can further including decoding of the identification signal 20 in order to prevent unauthorized access and provide desired security features to prevent unauthorized use of the vehicle.

During the authentication process that has begun with the external trigger, an operator will for example be entering the vehicle and desire to begin operation of the vehicle. Operation of the vehicle still requires insertion of the identification device 16 in the reader module 14. Depending on the amount of time that has elapsed since the external triggering event the actuation of the reader module by the identification device may allow immediate operation or may only require a reduced time as the authentication process has already begun. Engaging the reader module does not restart the authorization process but instead is accomplished parallel to the authorization process begun responsive to the initial external triggering event.

The authentication process will continue even while the identification key 16 is being read by the reader module 14 and does not start over as it has begun some short period after the external trigger has been recognized. In this way, the authentication process will be completed in a perceptively quicker time once the ID card 16 has been read by the reader module 14. However, engagement and communication between the ID card 16 and the reader module 14 is still required.

An ID card 16 is illustrated by way of example, however other identification devices such as electronic keys, key fobs, or any other known identification device and means can be utilized and are within the contemplation of this invention. Further, the example reader 14 is shown schematically and can include a card reader, or a defined space within which an identification device is placed.

The example disclosed immobilizer system 12 provides a method for decreasing wait times required for authenticating an identification device. The wait times are reduced by initializing authorization in response to an external triggering event. The authorization process begins prior to engagement of a reader module and continues after engagement with the reader module. By beginning the authorization process prior to engagement with the reader module the perceived wait time required for the authorization process is greatly reduced. Further, by still requiring engagement of an identification device by a reader module, the process and desired security parameters are maintained.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of authenticating an authorization device comprising the steps of:
a) triggering a search for an authorization device prior to engaging a reader;
b) establishing a communication link between the authorization device and an authorization system;
c) beginning authorization prior to engaging the reader;
d) engaging reader with the authorization device; and
e) allowing authorization responsive to completion of the authorization process begun prior to engaging the reader.

2. The method as recited in claim 1, wherein step a comprises a physical action that triggers the search for the authorization device.

3. The method as recited in claim 2, wherein the physical action comprises opening a door to a vehicle.

4. The method as recited in claim 2, wherein the physical action comprises actuating a remote keyless entry system to unlock a door of a vehicle.

5. The method as recited in claim 2, wherein the physical action comprises activation of a proximity sensor.

6. The method as recited in claim 1, wherein the reader comprises a defined space adjacent the authorization system.

7. The method as recited in claim 1, wherein step e comprises allowing authorization responsive to completion of the authorization process begun prior to engaging the reader only after engaging the reader.

8. The method as recited in claim 1, wherein the reader comprises a non-contact reader module disposed within a vehicle.

9. A method of authenticating an identification device for a vehicle immobilizer system, said method comprising the steps of:
a) triggering communication between the vehicle immobilizer system and an identification device without a reader module of the vehicle immobilizer system;
b) authenticating the identification device; and
c) authorizing operation of the vehicle once the identification device is placed in communication with the reader module upon completion of the authentication step begun prior to communication between the reader module and the identification device.

10. The method as recited in claim 9, wherein the step of triggering communication includes opening a door of the vehicle.

11. The method as recited in claim 9, wherein the step of triggering communication includes activating a vehicle proximity sensor.

12. The method as recited in claim 9, wherein the step of triggering communication includes actuation a remote keyless entry device.

13. The method as recited in claim 9, wherein the step of authenticating the identification device comprises the step of transmitting an identification code to the vehicle immobilizer system responsive to a prompt signal transmitted by the vehicle immobilizer system.

14. The method as recited in claim 9, including the step of completing the authentication of the identification device prior to engaging the reader module and authorizing operation of the vehicle only after the identification device is engaged to the reader module.

15. The method as recited in claim 9, wherein the identification device comprises a card and the reader module comprises a card reader.

16. The method as recited in claim 8, wherein the identification device comprises a key fob and the reader module comprises a space defined within the vehicle, and the step of engaging the reader module comprises placing the key fob within the defined space.
